(19) United States
(12) Patent Application Publication
(10) Pub. No.: US 2007/0250709 A1
(43) Pub. Date: Oct. 25, 2007

(54) Methods, apparatus, and computer programs for automatic detection and registration of IP multimedia devices situated in a customer device zone

(76) Inventor: Samuel Bailey JR., Atlanta, GA (US)

Correspondence Address: CANTOR COLBURN LLP - BELLSOUTH, 55 GRIFFIN ROAD SOUTH, BLOOMFIELD, CT, 06002, US

(21) Appl. No.: 11/408,322

(22) Filed: Apr. 21, 2006

(51) Int. Cl. H04L 9/00

(52) U.S. Cl. 713/168

(57) ABSTRACT

Methods, apparatus, and computer programs for providing encrypted data to an internet protocol (IP) multimedia subsystem (IMS)-capable device. The device is automatically detected when the device is situated in a customer device zone. The customer device zone comprises a spatial volume within which a signal transmitted by the device can be received, and a signal not transmitted by the device can be received by the device. In response to automatic detection of the device, a security key is transmitted to the device so as to enable the device to decode the encrypted data. The device is registered with an IP media subsystem by receiving one or more device attributes transmitted by the device in response to the device receiving the security key. The device attributes specify at least one of a media type, device type, or password for the device.

### BACKGROUND

The present invention relates generally to wireless data communication and, more particularly, to delivery of internet protocol (IP) multimedia services to any of a plurality of devices.

The IP Multimedia Subsystem (IMS) is an open, standardized multimedia architecture that provides network-controlled mobile and fixed IP services to customers. Cellular technologies are merged with the Internet to provide ubiquitous Internet-based services over wireless communication links. IMS utilizes a form of voice over Internet Protocol (VOIP) based upon a Third Generation Partnership Project (3GPP) variation of Standard Internet Protocol (SIP). IMS is used by telecom operators to implement next generation networks which combine voice and data in a single packet-switched network. The basic aim of IMS is not only to provide new services, but to provide all services, current and future, that the Internet is able to offer.

Existing International Telecommunications Union (ITU) and Third Generation Partnership Project (3GPP) standards do not adequately address the problem of automatically detecting and registering a plurality of disparate devices to be used by a customer for accessing IP multimedia services. With reference to FIG. 1, an IP multimedia subsystem (IMS) 100 includes a home subscriber server (HSS) 102 for providing multimedia services to one or more customer devices, such as first IMS-capable device 106, second IMS-capable device 108, and Nth IMS-capable device 110. These services illustratively include video, audio, communications, electronic commerce, and mechanisms for providing access to a physically secured area. Each respective IMS-capable device 106, 108, 110 includes a corresponding communication mechanism 107, 109, 111. Communication mechanisms 107, 109, 111 are implemented using RF transceivers, Bluetooth, infrared (IR) transceivers, communication ports capable of being connected to wired or fiber optic cable, or various combinations thereof.

Not infrequently, a customer may desire simultaneous access to different multimedia services downloaded over a plurality of IMS-capable devices 106, 108, 110. For example, a customer may wish to gain access to a secured area while, at the same time, listening to an audio program. Yet, before a device is allowed to access a service, the customer must manually register an IMS-capable device 106, 108, or 110 with IMS 100. The registration process uses a device-specific authentication procedure to verify that the customer is an authorized user, illustratively by receiving a customer-entered password. Next, the registered IMS-capable device 106, 108, 110 must be provided with a security key to enable the device to properly decode encrypted information received from IMS 100. Accordingly, a plurality of security keys 101 are stored on IMS 100. If the customer has been verified, then IMS 100 sends a security key to the registered IMS-capable device 106, 108, or 110. Device-specific authentication procedures and security keys are used to provide paying customers with access while, at the same time, preventing access by unauthorized users. However, pursuant to state of the art techniques, each of the customer's IMS-capable devices 106, 108, 110 must be registered separately, using a respective device-specific set of authentication methods to receive a corresponding security key.

When a customer wishes to access a first service (for example, an audio program) using first IMS-capable device 106, the customer is required to perform a first manual registration procedure, and the device must then receive a first security key from IMS 100. Subsequently, if the customer wishes to access a second service (for example, unlocking an electronically secured door) using second IMS-capable device 108, the customer must perform a second manual registration procedure, and the device must then receive a second security key from IMS 100. The first security key unlocks an electronic security lock 121 in first IMS-capable device 106, thus permitting device 106 to decode encrypted multimedia information downloaded from IMS 100. Similarly, the second security key unlocks an electronic security lock 123 in second IMS-capable device 108, thus permitting device 108 to decode encrypted multimedia information downloaded from IMS 100. Also, a third security key is used to unlock an electronic security lock in Nth IMS-capable device 110, thus permitting device 110 to decode encrypted multimedia information downloaded from IMS 100.

Performing multiple manual registration procedures is cumbersome and inconvenient in many situations, including the example give above where the customer's attention must be diverted from an ongoing audio program in order to gain access to a secured area. Moreover, each IMS-capable device 106, 108, 110 must include its own mechanism for generating and delivering device-specific authentication information to IMS 100, thereby increasing product development costs. This approach is unnecessarily complex, tedious, and time-consuming. What is needed is a technique for simplifying detection, authentication, and registration procedures for a plurality of disparate IMS-capable devices used by a single customer.

### BRIEF SUMMARY

Embodiments include methods for providing encrypted data to an internet protocol (IP) multimedia subsystem (IMS)-capable device. The methods comprise automatically detecting the IMS-capable device when the device is situated in a customer device zone. The customer device zone comprises a spatial volume within which a signal transmitted by the IMS-capable device can be received, and a signal not transmitted by the IMS-capable device can be received by the IMS-capable device. In response to automatic detection of the IMS-capable device, a security key is transmitted to the IMS-capable device so as to enable the IMS-capable device to decode the encrypted data. The IMS-capable device is registered with an IP media subsystem by receiving one or more device attributes transmitted by the IMS-capable device in response to the IMS-capable device receiving the security key. The device attributes specify at least one of a media type, device type, or password for the IMS-capable device.

Embodiments also include an apparatus for delivering encrypted data to an internet protocol (IP) multimedia subsystem (IMS)-capable device. The apparatus includes a transceiver for automatically detecting the IMS-capable device when the device is situated in a customer device zone. The customer device zone comprises a spatial volume within which a signal transmitted by the IMS-capable device can be received, and a signal not transmitted by the IMS-capable device can be received by the IMS-capable device. In response to automatic detection of the IMS-capable device, the transceiver is capable of transmitting a security key to the IMS-capable device so as to enable the IMS-capable device to decode the encrypted data. The transceiver is capable of receiving one or more device attributes transmitted by the IMS-capable device in response to the IMS-capable device receiving the security key. The device attributes specify at least one of a media type, device type, or password for the IMS-capable device.

Embodiments also include computer program products for establishing a trusted network. The computer program products include a storage medium readable by a processing circuit and storing instructions for execution by the processing circuit for facilitating a method. The facilitated method includes automatically detecting the IMS-capable device when the device is situated in a customer device zone. The customer device zone comprises a spatial volume within which a signal transmitted by the IMS-capable device can be received, and a signal not transmitted by the IMS-capable device can be received by the IMS-capable device. In response to automatic detection of the IMS-capable device, a security key is transmitted to the IMS-capable device so as to enable the IMS-capable device to decode the encrypted data. The IMS-capable device is registered with an IP media subsystem by receiving one or more device attributes transmitted by the IMS-capable device in response to the IMS-capable device receiving the security key. The device attributes specify at least one of a media type, device type, or password for the IMS-capable device.

Other systems, methods, and/or computer program products according to embodiments will be or become apparent to one with skill in the art upon review of the following drawings and detailed description. It is intended that all such additional systems, methods, and/or computer program products be included within this description, be within the scope of the present invention, and be protected by the accompanying claims.

### BRIEF DESCRIPTION OF DRAWINGS

Referring now to the drawings wherein like elements are numbered alike in the several FIGURES:

FIG. 1 is a block diagram illustrating a prior art configuration for providing multimedia services to a plurality of customer devices;

FIG. 2 is a block diagram illustrating a configuration for providing multimedia services to a plurality of customer devices according to various illustrative embodiments;

FIGS. 3A-3D together comprise a flowchart setting forth methods for providing multimedia services to a plurality of customer devices according to various illustrative embodiments; and

FIG. 4 is an illustrative device status list for use with the procedures of FIGS. 3A-3D.

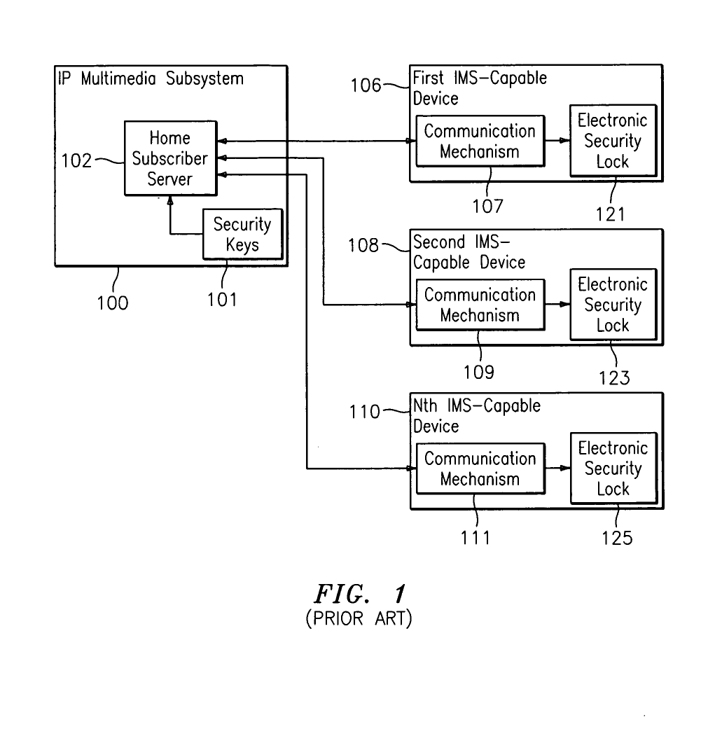

The detailed description explains exemplary embodiments, together with advantages and features, by way of example with reference to the drawings.

### DETAILED DESCRIPTION OF EXEMPLARY EMBODIMENTS

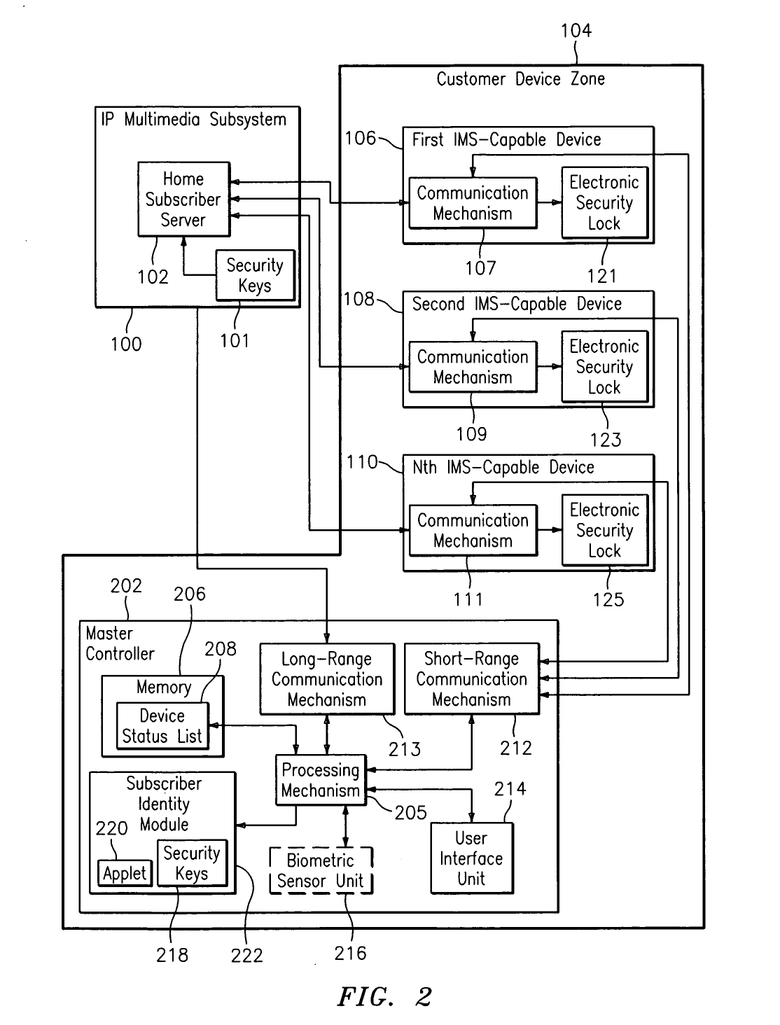

FIG. 2 is a block diagram illustrating a configuration for providing multimedia services to a plurality of customer devices according to various illustrative embodiments. An IP multimedia subsystem (IMS) 100 includes a home subscriber server (HSS) 102 for providing multimedia services to one or more customer devices, such as first IMS-capable device 106, second IMS-capable device 108, and Nth IMS-capable device 110. These services may include video, audio, communications, electronic commerce, gaining physical access to a secured area, or others. HSS 102 includes a user database that stores user profiles, and performs authentication and authorization of the user. Illustratively, first IMS-capable device 106 may represent a laptop computer capable of downloading encrypted data files representing audio from HSS 102, second IMS-capable device 108 may represent a security device capable of unlocking a door to a secured area in response to receipt of a security key , and Nth IMS-capable device 110 may represent a device capable of playing back encrypted audiovisual files representing movies, presentations, or the like that are downloaded from HSS 102.

Each IMS-capable device 106, 108, 110 includes a corresponding communication mechanism 107, 109, 111. Communication mechanisms 107, 109, 111 are implemented using radio frequency (RF) transceivers, Bluetooth, infrared (IR) transceivers, wired links, communication ports capable of being connected to conductive or fiber optic cable, or various combinations thereof. Examples of communication ports include, but are not limited, to universal serial bus (USB) ports, serial ports, parallel ports, telephone line connections, network connections, or various combinations thereof. The structure, functionality, and implementational details of IMS 100, HSS 102, IMS-capable devices 106, 108, 110 and short-range communication mechanisms 107, 109, 111 are matters within the knowledge of those having ordinary skill in the relevant art.

According to an exemplary embodiment, a master controller 202 represents any portable device, or combination of devices, that includes a processing mechanism 205, a communication mechanism (described hereinafter), a user interface unit 214, memory 206, and a mechanism for accepting a subscriber identity module 222. In the illustrative example of FIG. 2, the communication mechanism is shown as including a short-range communication mechanism 212 and a long-range communication mechanism 213. However, separate devices need not be utilized for short-range communication mechanism 212 and long-range communication mechanism 213, as one device could be employed to implement both short-range communication mechanism 212 and long-range communication mechanism 213. For example, short-range communication mechanism 213 could be implemented by using an RF amplifier to generate a relatively small amount of RF power, whereas communication mechanism 212 could be implemented by using this RF amplifier to generate a relatively greater amount of RF power.

Short-range communication mechanism 212 capable of communicating with one or more corresponding communication mechanisms 107, 109, 111 associated with each of respective IMS-capable devices 106, 108, 110. Short-range communication mechanism 212 is designed to communicate over relatively short distances, so as to define a customer device zone 104 within which a customer may wish to use a plurality of IP multimedia devices. Customer device zone 104 may encompass, for example, all or a portion of a customer's residence or place of business in proximity to master controller 202. Accordingly, a customer device zone 104 is defined as a spatial region within which communication between short-range communication mechanism 212 and any of communication mechanisms 107, 109, 111 takes place, irrespective of whether the communication takes place over a wired link, a wireless link, or a combination of a wired and a wireless link. Communication mechanisms 212, 107, 109, 111 may be implemented using infrared (IR) transceivers, RF transceivers such as Bluetooth, wired connections, or various combinations thereof. Long-range communication mechanism 213 is equipped to communicate with a wireless communications network such as a cellular network, a personal communications network, a next generation network, or the like.

In practice, master controller 202 may be implemented using a mobile telephone, a personal digital assistant (PDA), a pager, a BlackBerry personal electronic mail device, a laptop computer, or a microprocessor-based device. Processing mechanism 205 controls the operation of master controller 202 through the use of one or more application programs, such as applet 220, that can be loaded onto a subscriber identity module 222. Processing mechanism 205 may be implemented using a microprocessor, a microcontroller, logic circuitry, or various combinations thereof.

A smart card reader/writer and an erasable programmable read only memory (EPROM) may be employed to implement subscriber identity module 222. Memory 206 represents any computer-readable storage medium, such as floppy diskettes, CD ROMs, hard drives, or any other electronic, optical, or magnetic medium. Memory 206 is capable of storing computer program code for execution by processing mechanism 205. Memory 206 is also capable of storing a device status list 208 setting forth an operational status for one or more IMS-capable devices in customer device zone 104. The operational status identifies any IMS-capable device 106, 108, 110 that is currently providing a multimedia service to a customer, as well as any IMS-capable device 106, 108, 110 in customer device zone 104 that is available for providing a multimedia service to the customer.

First IMS-capable device 106 includes an electronic security lock 121 which has a locked state and an unlocked state. Upon receipt of a security key, electronic security lock 121 enters an unlocked state, thus permitting first IMS-capable device 106 to decode encrypted multimedia information downloaded from IMS 100. Similarly, second IMS-capable device 108 includes an electronic security lock 123 which has a locked state and an unlocked state. Upon receipt of a security key, electronic security lock 123 enters an unlocked state, thus permitting second IMS-capable device 108 to decode encrypted multimedia information downloaded from IMS 100. In this example, the encrypted multimedia information is an encrypted data signal that, when decoded, will unlock a door to a secured area. Also, Nth IMS-capable device 110 includes an electronic security lock 125 which has a locked state and an unlocked state. Upon receipt of a security key, electronic security lock 125 enters an unlocked state, thus permitting Nth IMS-capable device 110 to decode encrypted multimedia information downloaded from IMS 100. Security keys 101 are stored in IMS 100, and security keys 218 are stored at master controller 202. In operation, first, second or Nth IMS-capable devices may obtain a security key from master controller 202 or IMS 100.

Initially, master controller 202 is provided to a given customer for use in conjunction with any of a plurality of IMS-capable devices 106, 108, 110 that may be operated within customer device zone 104. The electronic security locks 121, 123, and 125 on devices 106, 108, 110 are initially set to a locked state, such that devices 106, 108, 110 are not able to download and decode encrypted multimedia information downloaded from IMS 100. A subscriber identity module 222 containing the customer's personal information is inserted into master controller 202. The customer then enters identifying indicia through a user interface unit 214. User interface unit 214 contains an input mechanism, illustratively an alphanumeric keypad, to allow entry of information. User interface unit 214 also includes a display device, illustratively a liquid crystal diode (LCD) display, for displaying information associated with the use of master controller 202. Those skilled in the art will appreciate that other display devices, such as a plasma display, or light emitting diode (LED) display, may replace the LCD display unit. Those skilled in the art will also appreciate that a LCD display touch screen may be used as an integrated display device and input mechanism, thereby replacing the alphanumeric keypad, and without altering the scope of the invention. Processing mechanism 205 is programmed to retrieve the identifying indicia stored on subscriber identity module 222 and compare it with identifying indicia supplied by the customer to user interface unit 214.

If the identifying indicia supplied by the customer matches the identifying indicia stored on subscriber identity module 222, then processing mechanism 205 enables master controller 202 to repeatedly monitor customer device zone 104 for the presence of any IMS-capable device 106, 108, or 110 within the zone. Customer device zone 104 is monitored by repeatedly or periodically activating short-range communication mechanism 212 to transmit signals which may be received by a respective communication mechanism 107, 109, or 111 of a corresponding IMS-capable device 106, 108, or 110 in customer device zone 104. Short-range communication mechanism 212 then repeatedly or periodically attempts to receive signals which may have been sent by a communication mechanism 107, 109, or 111 in response to the transmitted signal. Upon detection of an IMS-capable device 106, 108, or 110 in customer device zone 104, the detected device transmits a set of device attributes to master controller 202, the detected device registers with IMS 100, and master controller 202 or IMS 100 provides a security key to the detected device. Without this security key, the IMS-capable device would remain in an inoperative (disabled) condition.

If the identifying indicia supplied by the customer does not match the identifying indicia stored in subscriber identity module 222, then processing mechanism 205 does not initiate monitoring of customer device zone 104. Master controller 202 does not send security keys to any of the IMS-capable devices 106, 108, 110, thereby ensuring that the electronic security locks 121, 123, 125 of IMS-capable devices will remain in the locked state until the customer enters the correct identifying indicia into user interface unit 214.

Optionally, master controller 202 includes a biometric sensor unit 216. In cases where biometric sensor unit 216 is employed, the structure and functionality of user interface unit 214 may, but need not, be greatly simplified. For example, user interface unit 214 could be implemented using an audio annunciator or an indicator lamp to indicate successful (or unsuccessful) inputting of biometric information at biometric sensor unit 216. Biometric sensor unit 216 may contain a touch pad for collecting biometric data from the user, such as a fingerprint, thumb print, palm print, retinal scan, or various combinations thereof. Additionally or alternatively, biometric sensor unit 216 may be connected to a microphone for receiving voice inputs from the customer. Processing mechanism 205, in conjunction with subscriber identity module 222, processes the biometric data to verify the customer's identity.

Processing mechanism 205 compares the biometric data acquired from biometric sensor unit 216 with the user's biometric data stored on subscriber identity module 222. If the acquired biometric data matches the biometric data stored on subscriber identity module 222, then the customer's identity is validated and processing mechanism 205 commences monitoring customer device zone 104 for the presence of one or more IMS-capable devices 106, 108, 110 as discussed previously. It should be appreciated by those skilled in the art that biometric sensor unit 216 may be used separately, or in connection with a PIN (personal identification number) entered into user interface unit 214 to provide customer verification.

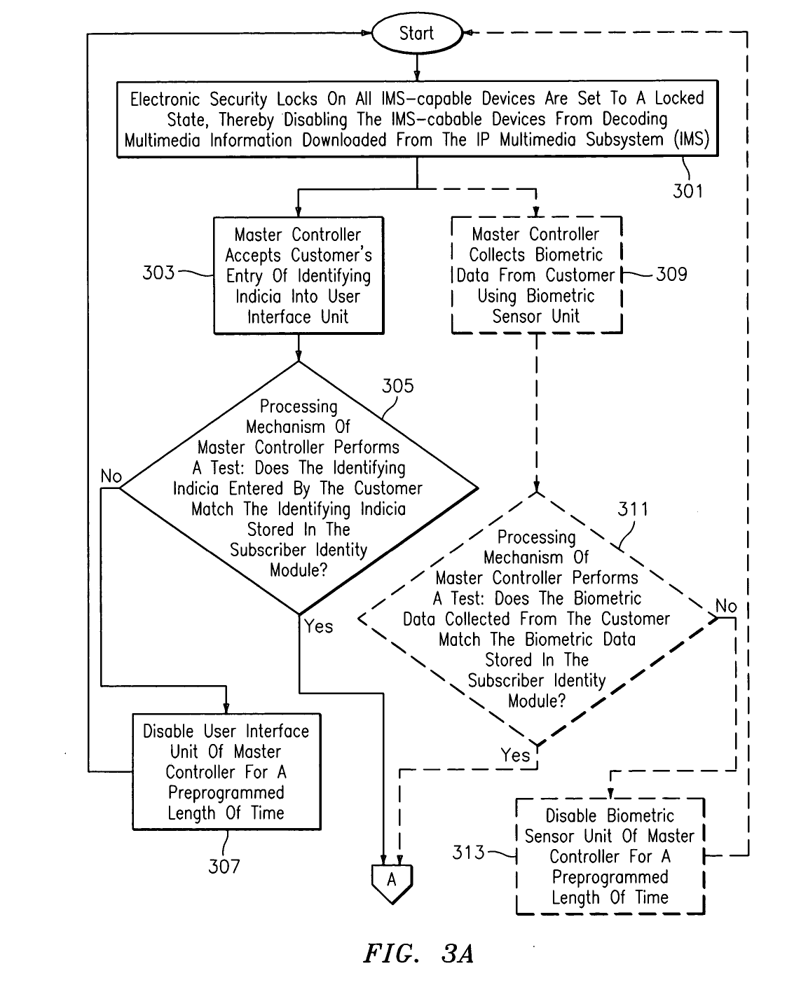

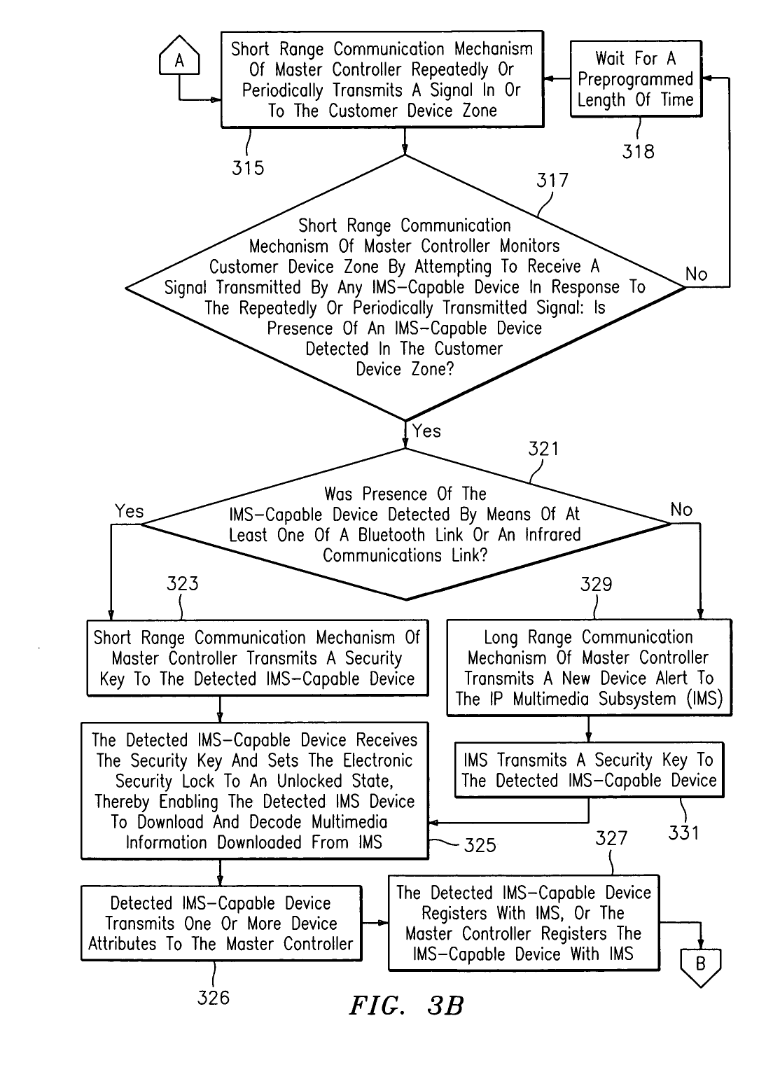

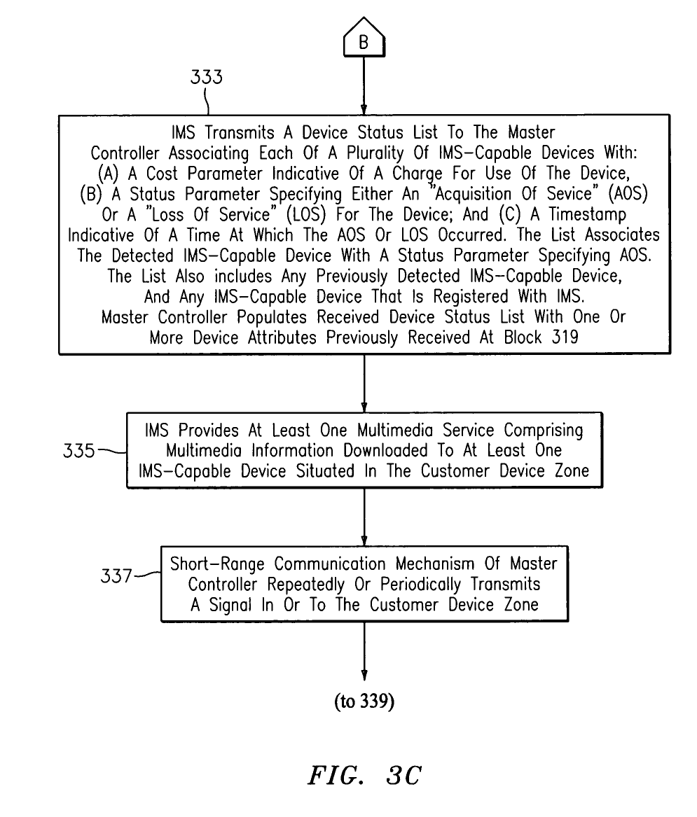

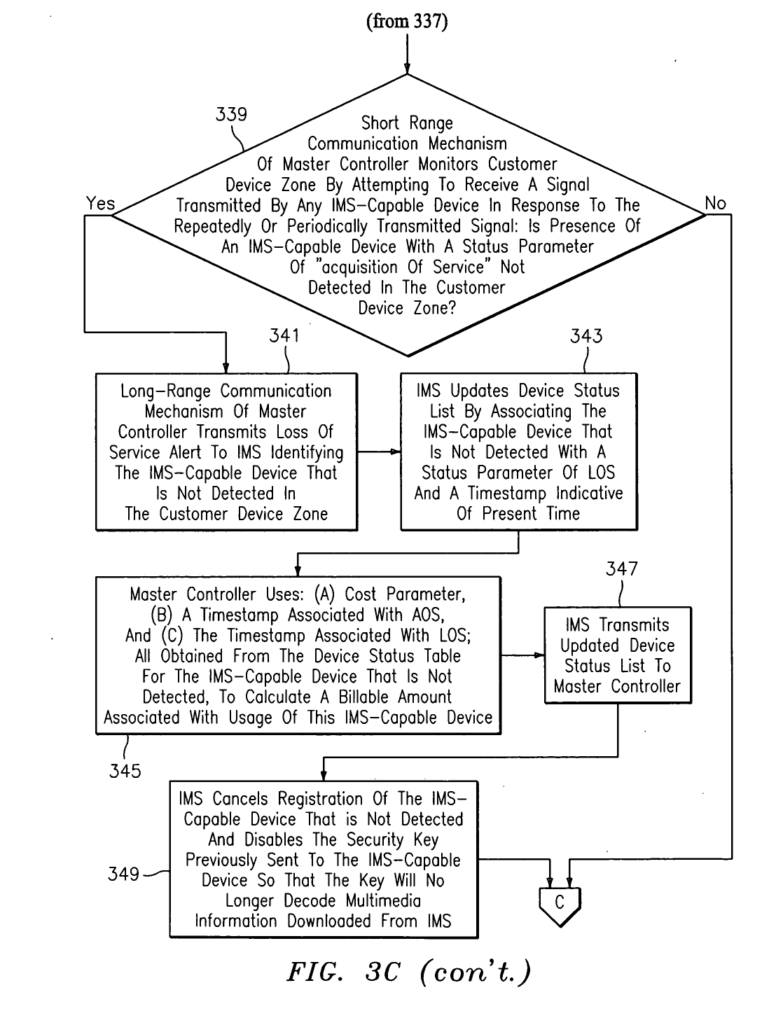

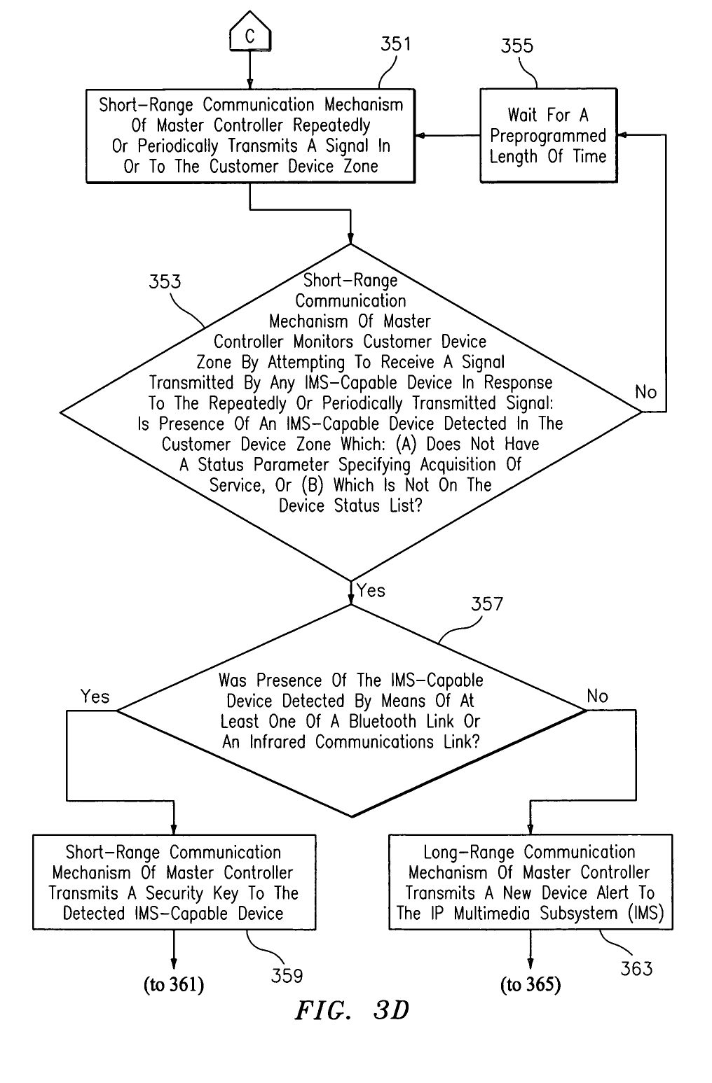

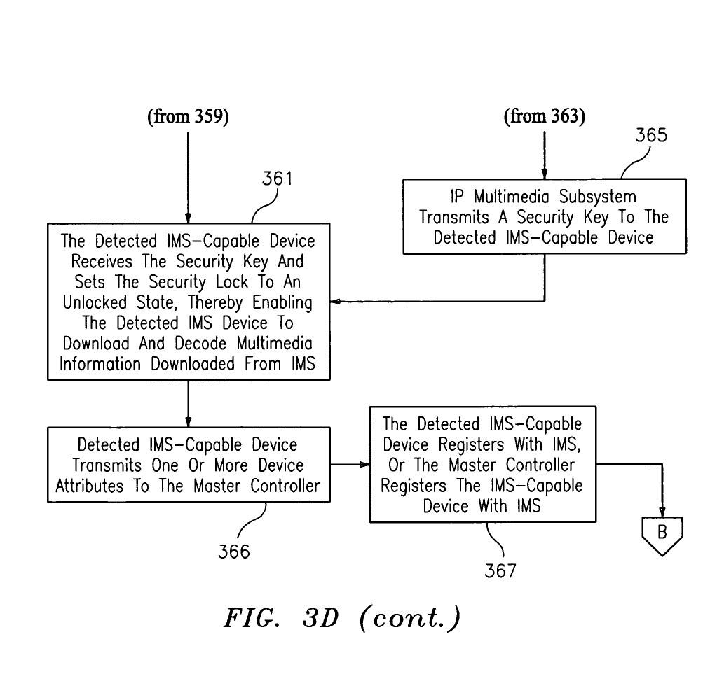

FIGS. 3A-3D together comprise a flowchart setting forth methods for providing multimedia services to a plurality of customer devices in accordance with various illustrative embodiments. The operational sequence of FIGS. 3A-3D commences at block 301 where electronic security locks 121, 123, 125 (FIG. 2) on all IMS-capable devices 106, 108, 110 are set to a locked state, thereby disabling the devices 106, 108, 110 from decoding encrypted multimedia information downloaded from IMS 100. Next (FIG. 3A, block 303), master controller 202 (FIG. 2) accepts a customer's entry of identifying indicia into user interface unit 214. Identifying indicia may include, for example, a PIN (personal identification) number, all or a portion of the name of the user, a password, a security key, or the like. At block 305 (FIG. 3A), processing mechanism 205 (FIG. 2) of the master controller performs a test to ascertain whether or not the identifying indicia entered by the customer matches the identifying indicia stored in subscriber identity module 222. If not, the user interface unit of the master controller is disabled for a preprogrammed length of time (FIG. 3A, block 307), and the program loops back to “start”. The affirmative branch from block 305 leads to block 315, to be described in greater detail hereinafter.

As an optional alternative or addition to blocks 303-307, the operational sequence of blocks 309-313 may be performed. At block 309, the master controller collects biometric data from a customer using biometric sensor unit 216 (FIG. 2). At block 311 (FIG. 3B), the processing mechanism performs a test to ascertain whether or not the biometric data collected from the customer matches the biometric data stored in the subscriber identity module. If not, the biometric sensor unit of the master controller is disabled for a preprogrammed length of time, and the program then loops back to “start”. The affirmative branch from block 311 leads to block 315.

At block 315, short-range communication mechanism 212 (FIG. 2) of master controller 202 repeatedly or periodically transmits a signal in or to customer device zone 104. Next, at block 317, the short-range communication mechanism of the master controller monitors the customer device zone by attempting to receive a signal transmitted by any IMS-capable device in response to the repeatedly or periodically transmitted signal. For example, the signal transmitted by short-range communication mechanism 212 may be received by a respective short-range communication mechanism 107, 109, or 111 of a corresponding IMS-capable device 106, 108, or 110 in customer device zone 104. In response to receipt of the signal transmitted by short-range communication mechanism 212, short range communication mechanism 107, 109, or 111 initiates transmission of a confirmation signal for receipt by short-range communication mechanism 212.

A test is performed at block 317 (FIG. 3B) to ascertain whether or not presence of an IMS-capable device (106, 108, 110) is detected in the customer device zone. If not, the program waits for a preprogrammed length of time (FIG. 3B, block 318) and performs the operations of block 315 and 317 again. The affirmative branch from block 317 leads to block 321 where a test is performed to ascertain whether or not presence of the IMS-capable device was detected by means of at least one of a Bluetooth link or an infrared (IR) communications link. If so, the short-range communication mechanism of the master controller transmits a security key to the detected IMS-capable device (block 323). The detected IMS-capable device receives the security key and sets the electronic security lock to an unlocked state, thereby enabling the detected IMS device to download and decode encrypted multimedia information downloaded from IMS (block 325). Until the security key is received by the IMS-capable device, the electronic security lock on the IMS-capable device remains locked, and the customer will not be able to decode encrypted downloaded information. At block 326, the detected IMS-capable device transmits a set of device attributes to the master controller. The set of device attributes illustratively includes at least one of a device type identifier specifying a particular hardware type such as a laptop computer, a logon password for the device, or a media type identifier specifying a media type such as audio, still video, or motion video. Next, at block 327, the detected IMS-capable device registers with IMS 100 (FIG. 2), or the master controller registers the detected IMS-capable device with IMS 100. The negative branch from block 321 (FIG. 3B) leads to block 329 where the long-range communication mechanism of the master controller transmits a new device alert to the IMS. The IMS transmits a security key to the detected IMS-capable device (block 331), and the program progresses to block 325, discussed previously.

Next, at block 333, the IMS transmits a device status list 208 (FIG. 2) to the master controller. The device status list associates each of a plurality of IMS-capable devices with: (A) a cost parameter indicative of a charge for use of the device; (B) a status parameter specifying either an “acquisition of service” (AOS) or a “loss of service” (LOS) for the device; and (C) a timestamp indicative of a time at which the acquisition of service or the loss of service occurred. The list associates the IMS-capable device previously detected in block 317 with a status parameter specifying AOS. The master controller populates the device attributes field of the detected IMS-capable device with one or more device attributes that were previously received at block 319. The device status list also includes any previously detected IMS-capable device in the customer device zone, and any IMS-capable device that is registered with IMS. At block 335 (FIG. 3C), the IMS provides at least one multimedia service comprising encrypted multimedia information downloaded to at least one IMS-capable device situated in the customer device zone. The at least one IMS-capable device could be the IMS-capable device that was previously detected in block 317, or another previously-detected IMS-capable device.

At block 337, the short-range communication mechanism of the master controller repeatedly or periodically transmits a signal in or to the customer device zone. The short-range communication mechanism of the master controller monitors the customer device zone to determine whether or not presence of an IMS-capable device with a status parameter of “acquisition of service” is not detected in the customer device zone (block 339). If the presence of an IMS-capable device with a status parameter of “acquisition of service” is not detected, the program progresses to block 341 where the long-range communication mechanism of the master controller transmits a loss of service alert to the IMS identifying the IMS-capable device that is not detected in the customer device zone. At block 343, the IMS updates the device status list by associating the IMS capable device that is not detected with a status parameter of LOS and a timestamp indicative of the present time. Next, the master controller obtains: (a) the cost parameter, (b) a timestamp associated with AOS, and (c) the timestamp associated with LOS; from the device status list to calculate a billable amount associated with usage of the IMS-capable device that is no longer detected in the customer device zone (block 345).

The IMS transmits the updated device status list to the master controller (block 347). The IMS then cancels registration of the IMS-capable device that is not detected and disable the security key previously sent to the device so that the device will no longer be able to decode multimedia information downloaded from the IMS (block 349). The program then advances to block 351 (FIG. 3D).

The negative branch from block 339 leads to block 351 where the short-range communication mechanism of the master controller repeatedly or periodically transmits a signal in or to the customer device zone. The short-range communication mechanism of the master controller then monitors the customer device zone to ascertain whether or not presence of an IMS-capable device is detected which (a) does not have a status parameter specifying “acquisition of service”, or (b) which is not on the device status list (block 353). If presence of an IMS-capable device satisfying either condition (a) or (b) is not detected, the program advances to block 355 where the program waits for a preprogrammed length of time before looping back to block 351. The affirmative branch from block 353 leads to block 357 where a test is performed to ascertain whether or not presence of the IMS-capable device was detected by means of at least one of a Bluetooth link or an infrared communications link. If so, the short-range communication mechanism of the master controller transmits a temporary key to the detected IMS-capable device (block 359). The detected IMS-capable device receives the security key and sets the security lock to the unlocked state, thereby enabling the detected IMS device to download and decode multimedia information downloaded from IMS (block 361). At block 366, the detected IMS-capable device transmits one or more device attributes to the master controller. The detected IMS-capable device registers with IMS (block 367), or the master controller registers the IMS-capable device with IMS, and the program loops back to block 333 (FIG. 3C).

The negative branch from block 357 leads to block 363 where the long-range communication mechanism of the master controller transmits a new device alert to the IMS. The IMS transmits a security key to the detected IMS-capable device (block 365). The detected IMS-capable device receives the security key and sets the security lock to the unlocked state, thereby enabling the detected IMS device to download and decode multimedia information downloaded from IMS (block 361). The detected IMS-capable device registers with IMS (block 367), and the program loops back to block 333 (FIG. 3C).

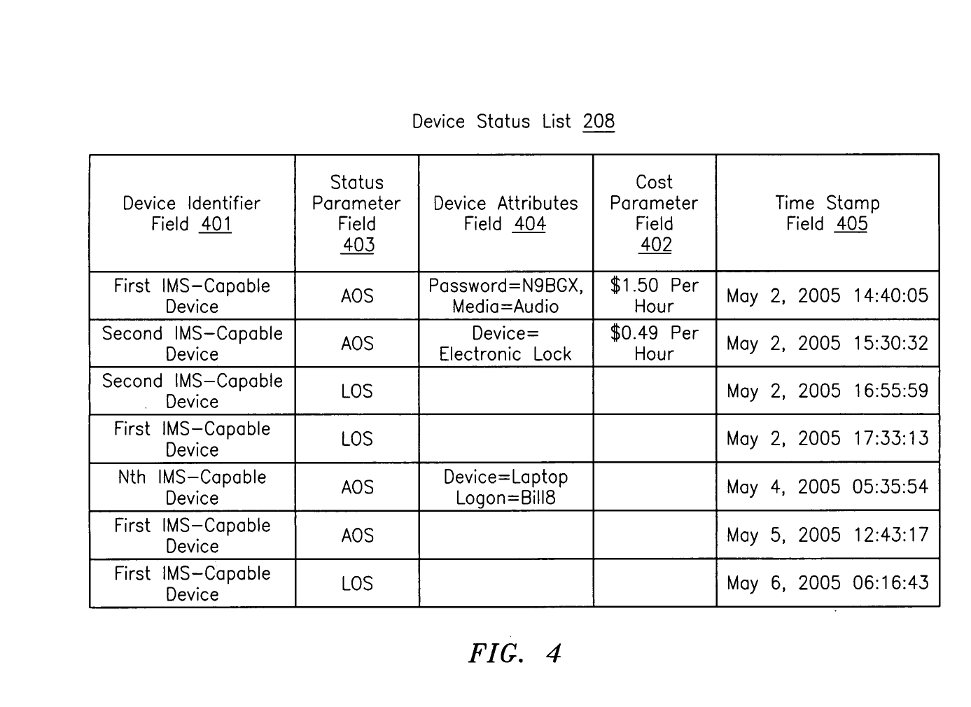

FIG. 4 is an illustrative device status list 208 for use with the procedures of FIGS. 3A-3D. Device status list 208 associates each of a plurality of IMS-capable device identifiers in device identifier field 401 with a status parameter in status parameter field 403, a cost parameter in cost parameter field 402, one or more device attributes in device attributes field 404, and a time stamp in time stamp field 405. The device identifier is any numeric, alphabetic, or alphanumeric sequence that uniquely identifies an IMS-capable device, such as first IMS-capable device 106. The status parameter identifies the status of a corresponding IMS-capable device (i.e., acquisition of service, or loss of service). The time stamp identifies the time at which the corresponding status was detected by master controller 202 (FIG. 2). The device attributes specify at least one of a device type (examples of which are a laptop computer, an electronic lock, or a personal digital assistant), a password used to log onto the device, or a media type used by the device (for example, audio, still video, or moving video).

In the example of FIG. 4, the master controller detected first IMS-capable device 106 (FIG. 2) in customer device zone 104 on May 2, 2005 at 14:40 PM, thereby associating the first IMS-capable device with a status parameter of “acquisition of service”. Next (FIG. 4), the master controller detected second IMS-capable device 108 (FIG. 2) in customer device zone 104 on May 2, 2005 at 15:30 PM. Then, on May 2, 2005 at 16:55 PM, the master controller no longer detected the second IMS-capable device in the customer device zone. Accordingly, the second IMS-capable device is associated with a status parameter indicating “loss of service”.

The present invention can be embodied in the form of computer-implemented processes and apparatuses for practicing those processes. The present invention can also be embodied in the form of computer program code containing instructions embodied in tangible media, such as floppy diskettes, CD ROMs, hard drives, or any other computer-readable storage medium, wherein, when the computer program code is loaded into and executed by a computer, the computer becomes an apparatus for practicing the invention. The present invention can also be embodied in the form of computer program code, for example, whether stored in a storage medium, loaded into and/or executed by a computer, or transmitted over some transmission medium, loaded into and/or executed by a computer, or transmitted over some transmission medium, such as over electrical wiring or cabling, through fiber optics, or via electromagnetic radiation, wherein, when the computer program code is loaded into an executed by a computer, the computer becomes an apparatus for practicing the invention. When implemented on a general-purpose microprocessor, the computer program code segments configure the microprocessor to create specific logic circuits.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiments disclosed for carrying out this invention, but that the invention will include all embodiments falling within the scope of the claims. Moreover, the use of the terms first, second, etc., do not denote any order or importance, but rather the terms first, second, etc., are used to distinguish one element from another. Furthermore, the use of the terms a, an, etc., do not denote a limitation of quantity, but rather denote the presence of at least one of the referenced item.

What is claimed is:

1. A method for providing encrypted data to an internet protocol (IP) multimedia subsystem (IMS)-capable device, the method comprising:
automatically detecting the IMS-capable device when the device is situated in a customer device zone comprising a spatial volume within which a signal transmitted by the IMS-capable device can be received and a signal not transmitted by the IMS-capable device can be received by the IMS-capable device;
in response to automatic detection of the IMS-capable device, transmitting a security key to the IMS-capable device so as to enable the IMS-capable device to decode the encrypted data; and
registering the IMS-capable device with an IP media subsystem by receiving one or more device attributes transmitted by the IMS-capable device in response to the IMS-capable device receiving the security key, the device attributes specifying at least one of a media type, device type, or password for the IMS-capable device.

2. The method of claim 1 wherein automatically detecting the IMS-capable device is performed by:
transmitting a signal in or to the customer device zone, and monitoring the customer device zone for a signal received from an IMS-capable device in response to the transmitted signal;
wherein, if a signal is received from the IMS-capable device, the IMS-capable device is regarded as having been automatically detected.

3. The method of claim 2 further comprising:
continuing to transmit a signal in or to the customer device zone; and
continuing to monitor the customer device zone for any signal received from the IMS-capable device in response to the transmitted signal; and
if no signal is received from the IMS-capable device in response to the transmitted signal, disabling the security key so as to disable the IMS-capable device.

4. The method of claim 2 wherein:
the encrypted data are provided to the IMS-capable device over a long-range communication link between the IMS-capable device and a wireless communications network;
transmitting a signal in or to the customer device zone is performed using a short-range communication link between the IMS-capable device and a master controller; and
the customer device zone is defined as a spatial volume within which communication between the IMS-capable device and the master controller takes place.

5. The method of claim 4 wherein the short-range communication link is implemented using at least one of Bluetooth transceivers, infrared (IR) transceivers, radio frequency (RF) transceivers, wired links, or communication ports capable of being connected to conductive or fiber optic cable.

6. The method of claim 2 further comprising receiving identifying indicia from a customer prior to transmitting a signal in or to the customer device zone; comparing the received identifying indicia with stored identifying indicia retrieved from memory; and, only if the received identifying indicia match the stored identifying indicia, then transmitting a signal in or to the customer device zone.

7. The method of claim 2 further comprising the IMS-capable device registering with an IP multimedia subsystem.

8. An apparatus for providing encrypted data to an internet protocol (IP) multimedia subsystem (IMS)-capable device, the apparatus comprising:
a transceiver for automatically detecting the IMS-capable device when the device is situated in a customer device zone comprising a spatial volume within which a signal transmitted by the IMS-capable device can be received and a signal not transmitted by the IMS-capable device can be received by the IMS-capable device;
in response to automatic detection of the IMS-capable device, the transceiver transmitting a security key to the IMS-capable device so as to enable the IMS-capable device to decode the encrypted data; and
the transceiver receiving one or more device attributes transmitted by the IMS-capable device in response to the IMS-capable device receiving the security key, the device attributes specifying at least one of a media type, device type, or password for the IMS-capable device.

9. The apparatus of claim 8 wherein the transceiver automatically detects the IMS-capable device by:
transmitting a signal in or to the customer device zone, and monitoring the customer device zone for a signal received from an IMS-capable device in response to the transmitted signal;
wherein, if a signal is received from the IMS-capable device, the IMS-capable device is regarded as having been automatically detected.

10. The apparatus of claim 9 wherein the transceiver continues to transmit a signal in or to the customer device zone, and continues to monitor the customer device zone for any signal received from the IMS-capable device in response to the transmitted signal;
the apparatus further comprising a disabling mechanism for disabling the security key if no signal is received from the IMS-capable device in response to the transmitted signal.

11. The apparatus of claim 9 further comprising:
a long-range communication link between the IMS-capable device and a wireless communications network, wherein the long-range communication link is capable of providing encrypted data to the IMS-capable device;
a short-range communication link between the IMS-capable device and a master controller; wherein the short-range communication link is capable of transmitting a signal in or to the customer device zone; and
the customer device zone is defined as a spatial volume within which communication between the IMS-capable device and the master controller takes place.

12. The apparatus of claim 11 wherein the short-range communication link is implemented using at least one of Bluetooth transceivers, infrared (IR) transceivers, radio frequency (RF) transceivers, wired links, or communication ports capable of being connected to conductive or fiber optic cable.

13. The apparatus of claim 9 wherein the transceiver is capable of receiving identifying indicia from a customer prior to transmitting a signal in or to the customer device zone;
the apparatus further comprising a processing mechanism associated with a memory, the processing mechanism being coupled to the transceiver and capable of comparing the received identifying indicia with stored identifying indicia retrieved from memory; and, only if the received identifying indicia match the stored identifying indicia, then activating the transceiver to transmit a signal in or to the customer device zone.

14. A computer program product for establishing a trusted network, the computer program product comprising:
a storage medium readable by a processing circuit and storing instructions for execution by the processing circuit for facilitating a method for providing encrypted data to an internet protocol (IP) multimedia subsystem (IMS)-capable device, the method comprising:
automatically detecting the IMS-capable device when the device is situated in a customer device zone comprising a spatial volume within which a signal transmitted by the IMS-capable device can be received and a signal not transmitted by the IMS-capable device can be received by the IMS-capable device;
in response to automatic detection of the IMS-capable device, transmitting a security key to the IMS-capable device so as to enable the IMS-capable device to decode the encrypted data; and
registering the IMS-capable device with an IP media subsystem by receiving one or more device attributes transmitted by the IMS-capable device in response to the IMS-capable device receiving the security key, the device attributes specifying at least one of a media type, device type, or password for the IMS-capable device.

15. The computer program product as recited in claim 14 wherein automatically detecting the IMS-capable device is performed by:
transmitting a signal in or to the customer device zone, and monitoring the customer device zone for a signal received from an IMS-capable device in response to the transmitted signal;
wherein, if a signal is received from the IMS-capable device, the IMS-capable device is regarded as having been automatically detected.

16. The computer program product as recited in claim 15 further comprising instructions for:
continuing to transmit a signal in or to the customer device zone; and
continuing to monitor the customer device zone for any signal received from the IMS-capable device in response to the transmitted signal; and
if no signal is received from the IMS-capable device in response to the transmitted signal, disabling the security key so as to disable the IMS-capable device.

17. The computer program product as recited in claim 15 wherein:
the encrypted data are provided to the IMS-capable device over a long-range communication link between the IMS-capable device and a wireless communications network;
transmitting a signal in or to the customer device zone is performed using a short-range communication link between the IMS-capable device and a master controller; and
the customer device zone is defined as a spatial volume within which communication between the IMS-capable device and the master controller takes place.

18. The computer program product as recited in claim 17 wherein the short-range communication link is implemented using at least one of Bluetooth transceivers, infrared (IR) transceivers, radio frequency (RF) transceivers, wired links, or communication ports capable of being connected to conductive or fiber optic cable.

19. The computer program product as recited in claim 15 further comprising instructions for receiving identifying indicia from a customer prior to transmitting a signal in or to the customer device zone; comparing the received identifying indicia with stored identifying indicia retrieved from memory; and, only if the received identifying indicia match the stored identifying indicia, then transmitting a signal in or to the customer device zone.

20. The computer program product as recited in claim 15 further comprising instructions for registering the IMS-capable device with an IP multimedia subsystem.
